(19) United States
(12) Patent Application Publication
(10) Pub. No.: US 2024/0005532 A1
(43) Pub. Date: Jan. 4, 2024

(54) DYNAMIC TRACKING METHODS FOR IN-VIVO THREE-DIMENSIONAL KEY POINT AND IN-VIVO THREE-DIMENSIONAL CURVE

(71) Applicant: Hefei University of Technology, Hefei City (CN)

(72) Inventors: Xiaojian LI, Hefei City (CN); Ling LI, Hefei City (CN); Shanlin YANG, Hefei City (CN); Youtong TANTAI, Hefei City (CN); Jin FANG, Hefei City (CN); Jieyu ZHENG, Hefei City (CN); Shuai DING, Hefei City (CN); Lin ZHANG, Hefei City (CN); Yanwei QU, Hefei City (CN); Hua TANG, Hefei City (CN); Liangkuan BI, Hefei City (CN)

(21) Appl. No.: 18/346,331

(22) Filed: Jul. 3, 2023

(30) Foreign Application Priority Data
Jul. 4, 2022 (CN) 202210779481.5
Jul. 4, 2022 (CN) 202210779486.8

(51) Int. Cl. G06T 7/246; G06T 7/73; G06T 7/50; G06T 7/60; G06T 3/00; G06V 10/46

(52) U.S. Cl. CPC G06T 7/248; G06T 7/74; G06T 7/50; G06T 7/60; G06T 3/0006; G06V 10/462; G06T 2207/10024; G06T 2207/10028; G06T 2207/10068; G06T 2207/30004

(57) ABSTRACT

Dynamic tracking methods for an in-vivo three-dimensional key point and an in-vivo three-dimensional curve can include mapping a first local region to a first local point cloud and mapping a second local region to a second local point cloud according to a mapping relation between an endoscopic image and the point clouds; determining a first three-dimensional key point of a first two-dimensional key point on the first local point cloud, and acquiring a second three-dimensional key point on the second local point cloud through a coordinate transformation; and mapping the second three-dimensional key point back to the second local region, so as to acquire a second two-dimensional key point from a next image; and acquiring two-dimensional coordinates of a tracked key point by minimizing a preset optimization function in combination with an initial two-dimensional key point, and finally acquiring corresponding three-dimensional coordinates.

### TECHNICAL FIELD

The present disclosure relates to the technical field of autonomous operation robots, and in particular to dynamic tracking methods for an in-vivo three-dimensional key point and an in-vivo three-dimensional curve.

### BACKGROUND

An autonomous operation robot capable of tele-operations solves the problem of uneven distribution of medical resources. With a three-dimensional key point and further an operation path tracked, the tele-operation can be guided more precisely and the operation robot can complete autonomous manipulation more remarkably.

Currently, it is common practice to label on a tissue or track, plan, and manipulate a three-dimensional key point and an operation path with the aid of a preoperative image in the prior art. For example, in “Supervised Autonomous Electrosurgery via Biocompatible Near-Infrared Tissue Tracking Techniques” (published on Transactions on Medical Robotics and Bionics, Institute of Electrical and Electronics Engineers (IEEE), November 2019), H. Saeidi, et al. have proposed that a supervised autonomous three-dimensional path planning, filtering, and control strategy is developed for a smart tissue autonomous robot (STAR) through a biocompatible near infrared (NIR) labeling method, red-green-blue+depth (RGBD), and a near infrared photographing system, so as to cut a complex soft tissue. For another example, in “Toward Autonomous Robotic Micro-Suturing using Optical Coherence Tomography Calibration and Path Planning” published in 2020, Tian, Y., et al. have proposed to use a robotic suturing system realizing imaging feedback by means of an optical coherence tomography (OCT) system. Accordingly, the imaging feedback is performed on the basis of OCT. A three-dimensional point cloud for suturing needle semantic segmentation is constructed. A suturing needle tip is precisely aligned with a point cloud target through an Iterative Closest Point (ICP).

However, the near infrared (NIR) labeling method is susceptible to various external factors such as light rays, bubbles, and bile, resulting in an invalid path. In the case of preoperative image based labeling, because of a flexible and dynamic in-vivo environment, a three-dimensional key point and an in-vivo three-dimensional curve are susceptible to an operation environment. Accordingly, a labeled path is affected and thus fails to be highly adaptive to changes of the in-vivo environment during an operation. In addition, in view of indistinct region features in the in-vivo environment, the doctor's intention cannot be accurately conveyed merely through registration, leading to mismatching during the operation. In view of that, dynamic tracking solutions for precisely locating an in-vivo three-dimensional key point and an in-vivo three-dimensional curve are to be provided immediately.

### SUMMARY

### (I) Technical Problems to be Solved

Aiming at the defects in the prior art, the present disclosure provides dynamic tracking methods for an in-vivo three-dimensional key point and an in-vivo three-dimensional curve, and an electronic apparatus. Therefore, the technical problem that a three-dimensional labeled path cannot be precisely located is solved.

### (II) Technical Solutions

In order to realize the above objective, the present disclosure employs the technical solutions as follows:

A minimally invasive key site navigation oriented dynamic tracking method for an in-vivo three-dimensional key point includes:
S11, reading an endoscopic image, and acquiring a first two-dimensional key point from a current image according to selection of a doctor;
S12, tracking a first local region encompassing the first two-dimensional key point on the current image, acquiring a second local region from a next image, and determining an initial two-dimensional key point of the first two-dimensional key point on the next image;
S13, mapping the first local region to a first local point cloud and mapping the second local region to a second local point cloud according to a mapping relation between the endoscopic image and the point clouds, determining a first three-dimensional key point of the first two-dimensional key point on the first local point cloud, and acquiring a second three-dimensional key point on the second local point cloud through a coordinate transformation; and
S14, mapping the second three-dimensional key point back to the second local region, so as to acquire a second two-dimensional key point from the next image, acquiring two-dimensional coordinates of a tracked key point by minimizing a preset optimization function in combination with the initial two-dimensional key point, and finally acquiring corresponding three-dimensional coordinates.

An electronic apparatus includes: one or more processors;
a memory; and
one or more programs, where the one or more programs are stored in the memory and configured to be executed by the one or more processors, and the program includes executing the above dynamic tracking method for an in-vivo three-dimensional key point.

A minimally invasive key trajectory navigation oriented dynamic tracking method for an in-vivo three-dimensional curve includes:
S21, reading an endoscopic image, acquiring an operation path curve from a current image according to selection of a doctor, and acquiring a plurality of first two-dimensional key points through which the operation path curve passes;
S22, tracking a first local region encompassing the first two-dimensional key point on the current image, and acquiring a second local region from a next image;
S23, mapping the first local region to a first local point cloud and mapping the second local region to a second local point cloud according to a mapping relation between the endoscopic image and the point clouds, determining a first three-dimensional key point of the first two-dimensional key point on the first local point cloud, and acquiring a second three-dimensional key point on the second local point cloud through a coordinate transformation;
S24, reducing a dimension of the first local point cloud to obtain a first two-dimensional point cloud, and acquiring a second two-dimensional key point of the first three-dimensional key point on the first two-dimensional point cloud;
reducing a dimension of the second local point cloud to obtain a second two-dimensional point cloud, and acquiring a third two-dimensional key point of the second three-dimensional key point on the second two-dimensional point cloud; and
acquiring two-dimensional coordinates of a tracked key point on the two-dimensional point cloud by minimizing a preset optimization function according to the second two-dimensional key point and the third two-dimensional key point; and
S25, acquiring three-dimensional coordinates of each tracked key point according to a mapping relation between the point clouds before and after dimension reduction, performing curve fitting, and finally obtaining a three-dimensional curve by means of tracking.

### (III) Beneficial Effects

The present disclosure provides the minimally invasive key site navigation oriented dynamic tracking method for an in-vivo three-dimensional key point and the minimally invasive key trajectory navigation oriented dynamic tracking method for an in-vivo three-dimensional curve. Compared with the prior art, the present disclosure has the beneficial effects as follows:

In the present disclosure, the doctor determines the key point on the curve on an intraoperative image upon his/her own knowledge and experience, and a transformation matrix is acquired through a three-dimensional affine transformation between the two point clouds; coordinates of a key point on a source point cloud are transformed through the transformation matrix; the first local region is mapped to the first local point cloud and the second local region is mapped to the second local point cloud according to the mapping relation between the endoscopic image and the point clouds; the first three-dimensional key point of the first two-dimensional key point on the first local point cloud is determined, and the second three-dimensional key point on the second local point cloud is acquired through the coordinate transformation; the second three-dimensional key point is mapped back to the second local region, so as to acquire the second two-dimensional key point on the next image; and the two-dimensional coordinates of the tracked key point are acquired by minimizing a preset optimization function in combination with the initial two-dimensional key point, and the corresponding three-dimensional coordinates are finally acquired. A selected key point is initially tracked through the three-dimensional affine transformation. The three-dimensional key point in the in-vivo environment is precisely and dynamically located and tracked in combination with texture information and optical flow information.

In the present disclosure, the first local region is mapped to the first local point cloud and the second local region is mapped to the second local point cloud according to the mapping relation between the endoscopic image and the point clouds; the first three-dimensional key point of the first two-dimensional key point on the first local point cloud is determined, and the second three-dimensional key point on the second local point cloud is acquired through the coordinate transformation; the dimension of the first local point cloud is reduced to obtain the first two-dimensional point cloud, and the second two-dimensional key point of the first three-dimensional key point on the first two-dimensional point cloud is acquired; the dimension of the second local point cloud is reduced to obtain the second two-dimensional point cloud, and the third two-dimensional key point of the second three-dimensional key point on the second two-dimensional point cloud is acquired; the two-dimensional coordinates of the tracked key point on the two-dimensional point cloud are acquired by minimizing the preset optimization function according to the second two-dimensional key point and the third two-dimensional key point; and the three-dimensional coordinates of each tracked key point are acquired according to the mapping relation between the point clouds before and after dimension reduction, curve fitting is performed, and the three-dimensional curve is finally obtained by means of tracking.

The local region is determined through a position of the key point and tracked to reduce mistracking of the three-dimensional key point. In combination with the texture information of the endoscopic image and shape information, the effect of an indistinct in-vivo environment feature is avoided to a certain extent. The three-dimensional key point is precisely located by constructing the optimization function on the point cloud after dimension reduction. Therefore, the inconsistency of a curve shape under different viewing angles is avoided.

In conclusion, according to the dynamic tracking methods for an in-vivo three-dimensional key point and an in-vivo three-dimensional curve of the present disclosure, the three-dimensional key point and the three-dimensional curve in the in-vivo environment can be precisely and dynamically located and tracked. Accordingly, the technical problem that the three-dimensional labeled path cannot be precisely located is solved while an operation path curve can be tracked in real time.

### BRIEF DESCRIPTION OF THE DRAWINGS

In order to describe the technical solutions in the embodiments of the present disclosure or in the prior art more clearly, the accompanying drawings required for describing the embodiments or the prior art are briefly described below. Apparently, the accompanying drawings in the following description show merely some embodiments of the present disclosure. Those of ordinary skill in the art can still derive other accompanying drawings from these accompanying drawings without creative efforts.

FIG. 1 is a schematic flowchart of a minimally invasive key site navigation oriented dynamic tracking method for an in-vivo three-dimensional key point according to Embodiment 1 of the present disclosure;

FIG. 2 is a relation diagram among an initial two-dimensional key point, a second two-dimensional key point, and a neighborhood point of the second two-dimensional key point according to Embodiment 1 of the present disclosure; and

FIG. 3 is a schematic flowchart of a minimally invasive key trajectory navigation oriented dynamic tracking method for an in-vivo three-dimensional curve according to Embodiment 2 of the present disclosure.

### DETAILED DESCRIPTION OF THE EMBODIMENTS

In order to make the objectives, technical solutions, and advantages in the embodiments of the present disclosure clearer, the technical solutions in the embodiments of the present disclosure are described clearly and completely. Apparently, the described embodiments are some embodiments rather than all embodiments of the present disclosure. All other embodiments derived by those of ordinary skill in the art based on the embodiments of the present disclosure without creative efforts fall within the scope of protection of the present disclosure.

Embodiments of the present disclosure provide dynamic tracking methods for an in-vivo three-dimensional key point and an in-vivo three-dimensional curve. Accordingly, the technical problems that a three-dimensional key point cannot be precisely located, and an operation path curve cannot be tracked in real time are solved.

The technical solutions in the embodiments of the present disclosure are intended to solve the above technical problems. A general idea is as follows:

A minimally invasive key site navigation oriented dynamic tracking method for an in-vivo three-dimensional key point according to an embodiment of the present disclosure is configured to dynamically track a manual site on the basis of a three-dimensional point cloud in a robot based tele-operation and mainly applied to, but not limited to, minimally invasive endoscopic operation scenes. The technical solution can be specifically summarized as follows: a doctor selects a key point from an intraoperative image and maps the key point to the three-dimensional point cloud. The key point is determined preliminary through a three-dimensional affine transformation between two point clouds. Then, an optimization function is constructed in combination with a feature descriptor and texture information such as an optical flow. A position of the key point is precisely determined in a neighborhood. Therefore, an endoscopic image oriented three-dimensional key point tracking is realized.

Aiming at a flexible and dynamic in-vivo environment, in the embodiment of the present disclosure, the key point is selected manually through the intraoperative image and updated in real time on the three-dimensional point cloud. Therefore, an operation path is updated accurately under a complex and changeable environment. Aiming at an indistinct in-vivo environment feature, the selected key point is tracked initially through the three-dimensional affine transformation, and the three-dimensional key point in the in-vivo environment is precisely and dynamically located and tracked in combination with the texture information and optical flow information.

A minimally invasive key trajectory navigation oriented dynamic tracking method for an in-vivo three-dimensional curve according to an embodiment the present disclosure is mainly applied to, but not limited to, minimally invasive endoscopic operation scenes. Accordingly, a tele-operation can be guided more precisely, and an operation robot can complete autonomous manipulation more remarkably.

In a scene application, the doctor plans a curved operation path on an intraoperative image upon his/her own knowledge and experience and determines a key point on a curve. A transformation matrix is acquired through a three-dimensional affine transformation between two point clouds. Coordinates of a key point on a source point cloud are transformed through the transformation matrix to obtain an initial position of a three-dimensional key point on a target point cloud. An optimization function is constructed in combination with the texture information of the endoscopic image and shape information of the curve. The three-dimensional key point is precisely located near an initial key point by minimizing the optimization function, and curve fitting is performed to realize dynamic curve fitting on the three-dimensional point cloud.

Aiming at a flexible and dynamic in-vivo environment, the operation path is planned manually through the intraoperative images and updated in real time on the three-dimensional point cloud. Therefore, the operation path is updated accurately under a complex and changeable environment. Aiming at an indistinct in-vivo environment feature, the key point on the curve is initially tracked through three-dimensional point cloud registration, and the curve in the in-vivo environment is precisely and dynamically located and tracked in combination with the texture information and the shape information.

For a better understanding of the above technical solutions, the above technical solutions are described in detail below with reference to the accompanying drawings and particular embodiments of the description.

### Embodiment 1

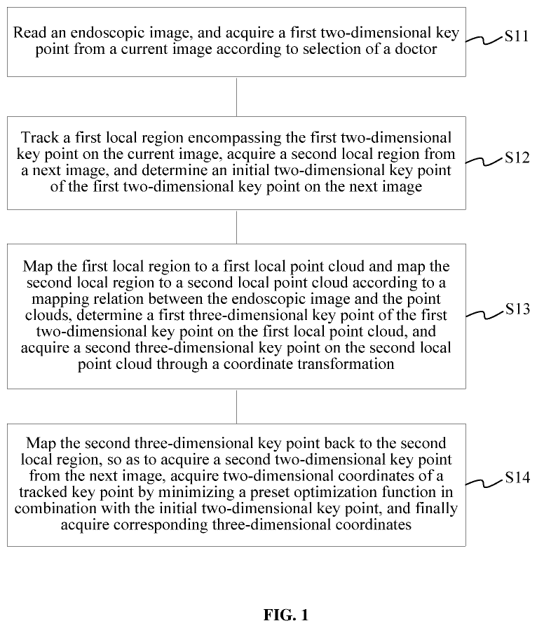

As shown in FIG. 1, an embodiment of the present disclosure provides a minimally invasive key site navigation oriented dynamic tracking method for an in-vivo three-dimensional key point. The method includes:
S11, an endoscopic image is read, and a first two-dimensional key point is acquired from a current image according to selection of a doctor;
S12, a first local region encompassing the first two-dimensional key point on the current image is tracked, a second local region is acquired from a next image, and an initial two-dimensional key point of the first two-dimensional key point on the next image is determined;
S13, the first local region is mapped to a first local point cloud and the second local region is mapped to a second local point cloud according to a mapping relation between the endoscopic image and the point clouds, a first three-dimensional key point of the first two-dimensional key point on the first local point cloud is determined, and a second three-dimensional key point on the second local point cloud is acquired through a coordinate transformation; and
S14, the second three-dimensional key point is mapped back to the second local region, so as to acquire a second two-dimensional key point from the next image, two-dimensional coordinates of a tracked key point are acquired by minimizing a preset optimization function in combination with the initial two-dimensional key point, and corresponding three-dimensional coordinates are finally acquired.

In the embodiment of the present disclosure, a selected key point is initially tracked through a three-dimensional affine transformation. The three-dimensional key point in the in-vivo environment is precisely and dynamically located and tracked in combination with texture information and optical flow information.

Each step of the above technical solution will be described in detail below with reference to specific contents:

In step S11, the endoscopic image is read, and the first two-dimensional key point is acquired from the current image according to selection of the doctor.

In the present step, the doctor labels the two-dimensional key point on an intraoperative image for subsequent display and update of the key point on a three-dimensional point cloud. Accordingly, the information is transmitted intuitively and accurately, and an operation efficiency is improved.

Step S12 that a first local region encompassing the first two-dimensional key point on the current image is tracked, a second local region is acquired from a next image, and an initial two-dimensional key point of the first two-dimensional key point on the next image is determined specifically includes:
S121, firstly, a k−1th image is defined as I(k−1)∈ [symbol] ^{W×H×3}, where W denotes a width of the endoscopic image, H denotes a height of the endoscopic image, I(k) denotes a kth image, and p(k−1) denotes a first two-dimensional key point, coordinates of which are (u₁, v₁); and
the first two-dimensional key point p(k−1) is taken as a center p^{c}(k−1) of the first local region, and a first local region [symbol] (k−1) is determined according to a preset region shape and side length;
S122, feature matching is performed on feature points of images I(k−1), I(k) through an optical flow method, a movement direction and a distance between two frames are acquired through average differences of pixel coordinates of a feature point pair, and a center, corresponding to p^{c}(k−1), of the second local region on the image I(k) is expressed as:

$${p}^{c} ( k ) = {p}^{c} ( k - 1 ) + \frac{1}{m} {\sum }_{i = 1}^{m} ( {p}_{i}^{f} ( k ) - {p}_{i}^{f} ( k - 1 ) )$$

where p^{c}(k) denotes the center of the second local region, coordinates of which are (u₂, v₂); and

p^{f}(k)={p₁^{f}(k),p₂^{f}(k), . . . ,pₘ^{f}(k)}

denotes a feature point on the image I(k), and m denotes the number of the feature point on the image I(k);
S123, a second local region [symbol] (k) is determined according to the center p^{c}(k) and the preset region shape and side length; and
S124, an initial two-dimensional key point p^{o}(k) of the first two-dimensional key point p(k−1) on the next image is directly determined still through the optical flow method.

Apparently, the above preset region shape and side length may be selected as actually required and will not be strictly limited herein. Taking a rectangular region [symbol] (k−1) with a size of L×L as an example, p^{c}(k−1) denotes a central point of the rectangular region [symbol] (k−1) on the endoscopic image I(k−1), where

$$( k - 1 ) = \{ {p}_{{u}_{1} + Δ u , {v}_{1} + Δ v}^{c} ( k - 1 ) \vert - \frac{L}{2} \leq Δ u , Δ v \leq \frac{L}{2} - 1 \}$$

$${p}_{{u}_{1} + Δ u , {v}_{1} + Δ v}^{c} ( k - 1 ) = ( {u}_{1} + Δ u , {v}_{1} + Δ v )$$

a rectangular area [symbol] (k) of the kth image is:

$$( k ) = \{ {p}_{{u}_{2} + Δ u , {v}_{2} + Δ v}^{c} ( k ) \vert - \frac{L}{2} \leq Δ u , Δ v \leq \frac{L}{2} - 1 \}$$

$${p}_{{u}_{2} + Δ u , {v}_{2} + Δ v}^{c} ( k ) = ( {u}_{2} + Δ u , {v}_{2} + Δ v )$$

In the embodiment of the present disclosure, when the three-dimensional key point is tracked, the local region is first determined according to a position of the key point and tracked to reduce mistracking of the three-dimensional key point.

In step S13, the first local region is mapped to the first local point cloud and the second local region is mapped to the second local point cloud according to the mapping relation between the endoscopic image and the point clouds, the first three-dimensional key point of the first two-dimensional key point on the first local point cloud is determined, and the second three-dimensional key point on the second local point cloud is acquired through the coordinate transformation.

In the present step, the three-dimensional key point is initially located. The three-dimensional key point may be initially located in the following two steps.

Firstly, a corresponding three-dimensional key point of a two-dimensional key point on the point cloud is determined through a position of the two-dimensional key point according to the mapping relation between the endoscopic image and the point cloud. Secondly, a tissue in the local region may be approximately deemed as a rigid body; and the transformation matrix between the point clouds is solved through the three-dimensional affine transformation, and a three-dimensional key point on a target point cloud is acquired through a coordinate transformation.

Correspondingly, S13 specifically includes:
S131, a depth of the endoscopic image is estimated through a neural network to obtain a depth image corresponding to the endoscopic image, space information and color information of each pixel are acquired from the depth image and the endoscope image respectively through reading in rows, and a first local point cloud [symbol] (k−1) and a second local point cloud [symbol] (k) are acquired;
S132, a first three-dimensional key point P(k−1)∈ [symbol] ³ of the first two-dimensional key point p(k−1) on the first local point cloud [symbol] (k−1) is determined,

P(k−1)=ψ(p(k−1))
where denotes a mapping relation from [symbol] (k−1) to [symbol] (k−1), which is recorded as [symbol] (k−1)→ [symbol] (k−1);
S133, in order to acquire a least squares observation, a feature point pair of the local regions [symbol] (k−1), [symbol] (k) is acquired through the optical flow method and recorded as X and Y, respectively, so that X and Y are in a coordinate transformation relation:

$$Y = [ \begin{matrix}A & t\end{matrix} ] [ \begin{matrix}X \\ 1\end{matrix} ]$$

where A∈ [symbol] ^{3×3}, t∈ [symbol] ^{3×1}, ω=[A t]^{T}∈ [symbol] ^{4×3} denote parameters of a fitting function, ω is acquirable from the following formula through least squares:

ω=([X1]^{T}[X1])⁻¹[X1]^{T}Y
and a transformation matrix of an affine transformation of P(k−1), P(k) is:

$${T}_{A} = [ \begin{matrix}A & t \\ {0}^{T} & 1\end{matrix} ] ∈ {R}^{4 \times 4}$$

where 0^{T}=(0,0,0); and
S134, a three-dimensional affine transformation is performed on the first three-dimensional key point P(k−1), where a matrix form is:

P(k)=T_{A}P(k−1)
and a nearest point is searched for from the second local point cloud [symbol] (k) to obtain an initial position of a second three-dimensional key point P(k).

In step S14, the second three-dimensional key point is mapped back to the second local region, so as to acquire the second two-dimensional key point from the next image. The two-dimensional coordinates of the tracked key point are acquired by minimizing the preset optimization function in combination with the initial two-dimensional key point, and the corresponding three-dimensional coordinates are finally acquired.

In the present step, the three-dimensional key point is precisely located. In the in-vivo environment, the tissue is dynamic, flexible, and highly similar. Therefore, in the embodiment of the present disclosure, the optimization function is constructed through texture information of a key point neighborhood, and the three-dimensional key point is precisely located by minimizing the optimization function.

Specifically, firstly, the second three-dimensional key point P(k) is mapped back to the second local region [symbol] (k) according to the mapping relation between the endoscopic image and the point cloud, and a second two-dimensional key point p(k) is acquired from the next image.

Then, the two-dimensional coordinates of the tracked key point are acquired by minimizing the preset optimization function in combination with the initial two-dimensional key point p^{o}(k), and the corresponding three-dimensional coordinates are finally acquired.

The above optimization function is as follows:

[symbol]

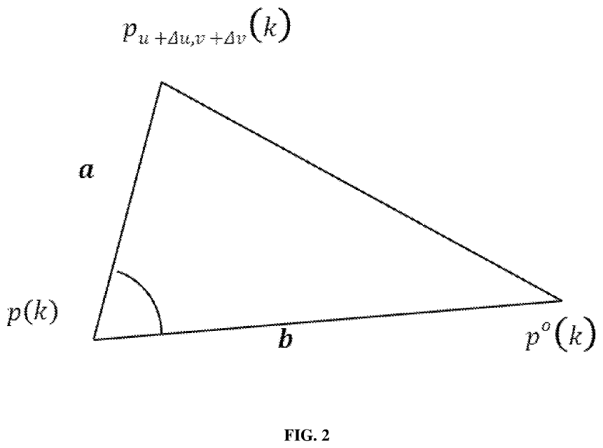

=2− [symbol] _{sift}− [symbol] _{optical}
where [symbol] denotes the optimization function;
[symbol] _{sift} denotes a cosine similarity of a scale invariant feature transform (SIFT) feature vector:

$${J}_{sift} ( Δ u , Δ v , k ) = \frac{{ϕ ( p ( k - 1 ) )}^{T} ϕ ( {p}_{u + Δ u , v + Δ v} ( k ) )}{‖ ϕ ( p ( k - 1 ) ) ‖ ‖ ϕ ( {p}_{u + Δ u , v + Δ v} ( k ) ) ‖}$$

where ϕ(p(k−1)) denotes a feature descriptor of the first two-dimensional key point p(k−1) and is a vector, ∥·∥ denotes a norm of the vector, (u, v) denote coordinates of the second two-dimensional key point p(k), p_{u+Δu,v+Δv}(k) denotes a neighborhood point of the second two-dimensional key point p(k), Δu and Δv are coordinate offset of the second two-dimensional key point p(k), ϕ(p_{u+Δu,v+Δv}(k)) denotes a feature descriptor of the neighborhood point p_{u+Δu,v+Δv}(k) and is a vector, and
[symbol] _{optical} denotes an effect of optical flow information:

$${J}_{optical} ( Δ u , Δ v , k ) = \frac{{a}^{T} b}{‖ a ‖ ‖ b ‖}$$

where vectors a, b are defined as in FIG. 2:

a=(p_{u+Δu,v+Δv}(k)−p(k))^{T},b=(p^{o}(k)−p(k))^{T}.

Δû and Δ\hat{v} are acquired by traversing and searching for Δu and Δv, so as to satisfy the following expression:

$$( Δ \hat{u} ( k ) , Δ \hat{v} ( k ) ) = {arg min}_{( Δ u , Δv )} ( J ( Δ u , Δ v , k ) )$$

Two-dimensional coordinates of a tracked key point p_{u+Δu,v+Δv}(k) are acquired after ideal offset (Δû(k), Δ\hat{v}(k)) is obtained, and then corresponding three-dimensional coordinates are finally acquired according to the mapping relation between the endoscopic image and the point cloud.

In the embodiment of the present disclosure, after the transformation matrix is acquired through the three-dimensional affine transformation, the three-dimensional key point is precisely located by constructing the optimization function in combination with the texture information and the optical flow information of the endoscopic image. Therefore, the effect of the indistinct in-vivo environment feature on a tracking result is avoided to a certain extent.

In conclusion, compared with the prior art, the present embodiment has the beneficial effects as follows:
1. In the embodiment of the present disclosure, the selected key point is initially tracked through the three-dimensional affine transformation. The three-dimensional key point in the in-vivo environment is precisely and dynamically located and tracked in combination with the texture information and the optical flow information.
2. In the embodiment of the present disclosure, the doctor labels the two-dimensional key point on the intraoperative image for subsequent display and update of the key point on the three-dimensional point cloud. Accordingly, the information is transmitted intuitively and accurately, and the operation efficiency is improved.
3. In the embodiment of the present disclosure, when the three-dimensional key point is tracked, the local region is firstly determined according to the position of the key point and tracked to reduce mistracking of the three-dimensional key point.
4. In the embodiment of the present disclosure, after the transformation matrix is acquired through the three-dimensional affine transformation, the three-dimensional key point is precisely located by constructing the optimization function in combination with the texture information and the optical flow information of the endoscopic image. Therefore, the effect of the indistinct in-vivo environment feature on the tracking result is avoided to a certain extent.

### Embodiment 2

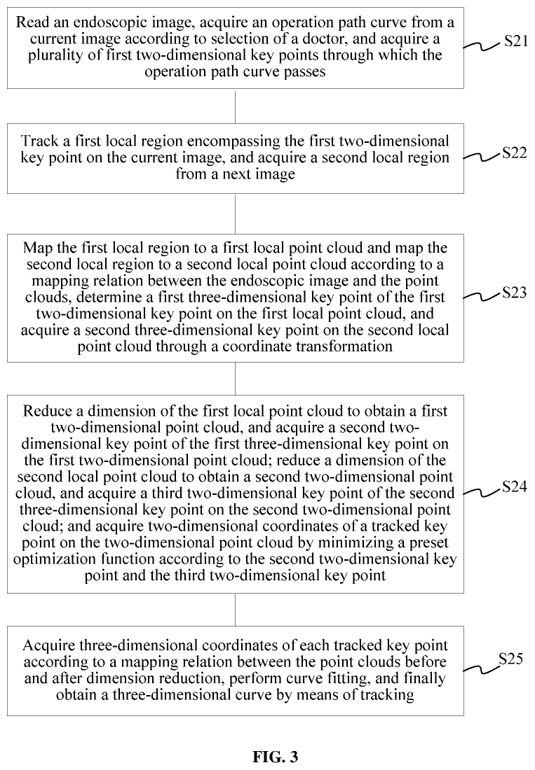

As shown in FIG. 3, an embodiment of the present disclosure provides a minimally invasive key trajectory navigation oriented dynamic tracking method for an in-vivo three-dimensional curve. The method includes:
S21, an endoscopic image is read, an operation path curve is acquired from a current image according to the selection of a doctor, and a plurality of first two-dimensional key points through which the operation path curve passes are acquired;
S22, a first local region encompassing the first two-dimensional key point on the current image is tracked, and a second local region is acquired from a next image;
S23, the first local region is mapped to a first local point cloud and the second local region is mapped to a second local point cloud according to a mapping relation between the endoscopic image and the point clouds, a first three-dimensional key point of the first two-dimensional key point on the first local point cloud is determined, and a second three-dimensional key point on the second local point cloud is acquired through a coordinate transformation;
S24, a dimension of the first local point cloud is reduced to obtain a first two-dimensional point cloud, and a second two-dimensional key point of the first three-dimensional key point on the first two-dimensional point cloud is acquired;
a dimension of the second local point cloud is reduced to obtain a second two-dimensional point cloud, and a third two-dimensional key point of the second three-dimensional key point on the second two-dimensional point cloud is acquired; and
two-dimensional coordinates of a tracked key point on the two-dimensional point cloud are acquired by minimizing a preset optimization function according to the second two-dimensional key point and the third two-dimensional key point; and
S25, three-dimensional coordinates of each tracked key point are acquired according to a mapping relation between the point clouds before and after dimension reduction, curve fitting is performed, and a three-dimensional curve is finally obtained by means of tracking.

In the embodiment of the present disclosure, the local region is determined through a position of the key point and tracked to reduce the mistracking of the three-dimensional key point. In combination with texture information of the endoscopic image and shape information, the effect of the indistinct in-vivo environment feature is avoided to a certain extent. The three-dimensional key point is precisely located by constructing the optimization function on the point cloud after dimension reduction. Therefore, the inconsistency of a curve shape under different viewing angles is avoided.

Each step of the above technical solution will be described in detail below with reference to specific contents:

In step S21, the endoscopic image is read, the operation path curve is acquired from the current image according to selection of the doctor, and the plurality of first two-dimensional key points through which the operation path curve passes are acquired.

A first two-dimensional key point acquisition process in S21 includes:

[symbol]

^{p}={p₀^{p}, . . . ,pⱼ^{p} . . . ,pₗ₋₁^{p}}
is defined as a pixel through which the operation path curve passes; where
   for a point on the curve, a curvature of a jth pixel on the curve is:

$${K}_{j} = \frac{{v}_{j + α} - {v}_{j}}{{u}_{j + α} - {u}_{j}} , j = 0 , α , 2 α … , j < l - 1 ,$$

where p_{j+α}^{p}=[u_{j+α} vⱼ₊ₐ] denotes coordinates of a j+αth pixel on the curve, and α denotes an interval number of the pixels when the curvature of the pixel is solved; and
for curvatures of two consecutive pixels, when |K_{j+α}−Kⱼ|≥ε, ε denotes a curvature threshold; and all first two-dimensional key points [symbol] ={p₁, . . . , pᵢ, . . . , pₙ} are determined in combination with p_{j+α}^{p} as a key point on the operation path curve and a start point and an end point of the curve, where n denotes a total number of the first two-dimensional key points.

In the present step, the doctor labels a three-dimensional curve on an intraoperative image for subsequent display and update of the curve on a three-dimensional point cloud. Accordingly, information is transmitted intuitively and accurately, and an operation efficiency is improved. Moreover, the key point is determined according to the curvature of the curve, and a computation speed is ensured for key point tracking.

Step S22 that a first local region encompassing the first two-dimensional key point on the current image is tracked, and a second local region is acquired from a next image specifically includes:
S221, firstly, a k−1th image is defined as I(k−1)∈ [symbol] ^{W×H×3}, where W denotes a width of the endoscopic image, H denotes a height of the endoscopic image, I(k) denotes a kth image, and [symbol] (k−1)={p₁(k−1), . . . , pₙ(k−1)} denote a plurality of first two-dimensional key points; and
maximums and minimums of all the first two-dimensional key points on a u axis and a v axis of an image coordinate system are determined, respectively, a position of a median on each axis is selected as p^{c}(k−1)=(u₁, v₁)∈R², and a first local region [symbol] (k−1) is determined according to a preset region shape and side length;
S222, feature matching is performed on feature points of images I(k−1), I(k) through the optical flow, and a center p^{c}(k), corresponding to p^{c}(k−1), of the second local region is acquired from the image I(k),

$${p}^{c} ( k ) = {p}^{c} ( k - 1 ) + \frac{1}{m} {\sum }_{i = 1}^{m} ( {p}_{i}^{f} ( k ) - {p}_{i}^{f} ( k - 1 ) )$$

where p^{f}(k)={p₁^{f}(k), p₂^{f}(k), . . . , pₘ^{f}(k)} denotes a feature point on the image I(k), and m denotes the number of the feature point on the image I(k); and
S223, a second local region [symbol] (k) is determined according to the center p^{c}(k) and the preset region shape and side length.

In the embodiment of the present disclosure, the local region is determined through a position of the key point and tracked to reduce mistracking of the three-dimensional key point.

In step S23, the first local region is mapped to the first local point cloud and the second local region is mapped to the second local point cloud according to the mapping relation between the endoscopic image and the point clouds, the first three-dimensional key point of the first two-dimensional key point on the first local point cloud is determined, and the second three-dimensional key point on the second local point cloud is acquired through the coordinate transformation.

In the present step, the three-dimensional key point is initially located. The three-dimensional key point may be initially located in the following two steps.

Firstly, a corresponding three-dimensional key point of a two-dimensional key point on the point cloud is determined through a position of the two-dimensional key point according to the mapping relation between the endoscopic image and the point cloud. Secondly, a tissue in the local region may be approximately deemed as a rigid body; and a transformation matrix between the point clouds is solved through a three-dimensional affine transformation, and a three-dimensional key point on a target point cloud is acquired through a coordinate transformation.

Correspondingly, S23 specifically includes:
S231, a depth of the endoscopic image is estimated to obtain a depth image corresponding to the endoscopic image, space information and color information of each pixel are acquired from the depth image and the endoscopic image respectively through reading in rows, and a first local point cloud [symbol] (k−1) and a second local point cloud [symbol] (k) are acquired;
S232, a first three-dimensional key point [symbol] (k−1)={P₁(k−1), . . . , Pₙ(k−1)}⊂ [symbol] (k−1), Pᵢ(k−1)∈ [symbol] ³ of the first two-dimensional key point [symbol] (k−1) on the first local point cloud [symbol] (k−1) is determined,

Pᵢ(k−1)=ψ(pᵢ(k−1))
where ψ denotes a mapping relation from [symbol] (k−1) to [symbol] (k−1), which is recorded as [symbol] (k−1)→ [symbol] (k−1);
S233, a feature point pair of the local regions [symbol] (k−1), [symbol] (k) is acquired through the optical flow method and recorded as X and Y, respectively, so that X and Y are in a coordinate transformation relation:

$$Y = [ \begin{matrix}A & t\end{matrix} ] [ \begin{matrix}X \\ 1\end{matrix} ]$$

where A∈ [symbol] ^{3×3}, t∈ [symbol] ^{3×1}, ω=[A t]^{T}∈ [symbol] ^{4×3} denote parameters of a fitting function, ω is acquirable from the following formula through least squares:

ω=([X1]^{T}[X1])⁻¹[X1]^{T}Y
and a transformation matrix of an affine transformation of P(k−1), P(k) is:

$${T}_{A} = [ \begin{matrix}A & t \\ {0}^{T} & 1\end{matrix} ] ∈ {ℝ}^{4 \times 4}$$

where 0^{T}=(0,0,0); and
S234, a three-dimensional affine transformation is performed on the first three-dimensional key point [symbol] (k−1), and a nearest point is searched for from the second local point cloud [symbol] (k) to obtain an initial position of a second three-dimensional key point [symbol] (k), where

[symbol]

(k)=T_{A} [symbol] (k−1).

In step S24, the dimension of the first local point cloud is reduced to obtain the first two-dimensional point cloud, and the second two-dimensional key point of the first three-dimensional key point on the first two-dimensional point cloud is acquired;
the dimension of the second local point cloud is reduced to obtain the second two-dimensional point cloud, and the third two-dimensional key point of the second three-dimensional key point on the second two-dimensional point cloud is acquired; and
the two-dimensional coordinates of the tracked key point on the two-dimensional point cloud are acquired by minimizing the preset optimization function according to the second two-dimensional key point and the third two-dimensional key point.

In the present step, the three-dimensional key point is precisely located. In order to ensure the accuracy when the curve dynamically changes, it is required to optimize the initial position of the key point on the curve.

In the present step, firstly, in combination with the texture information of the endoscopic image and the shape information, the effect of the indistinct in-vivo environment feature is avoided to a certain extent. Secondly, the three-dimensional key point is precisely located by constructing the optimization function on the point cloud after dimension reduction. Therefore, the inconsistency of a curve shape under different viewing angles is avoided.

Specifically, firstly, a dimension of the first local point cloud [symbol] (k−1) is reduced to obtain a first two-dimensional point cloud Q(k−1), and an ith second two-dimensional key point Tᵢ(k−1) of the first three-dimensional key point [symbol] (k−1) on the first two-dimensional point cloud Q(k−1) is acquired; and
a dimension of the second local point cloud [symbol] (k) is reduced to obtain a second two-dimensional point cloud Q(k), and an ith third two-dimensional key point Tᵢ(k) of the second three-dimensional key point [symbol] (k) on the second two-dimensional point cloud Q(k) is acquired.

Then two-dimensional coordinates of the tracked key point on the two-dimensional point cloud are acquired by minimizing the preset optimization function according to the second two-dimensional key point and the third two-dimensional key point.

The optimization function is as follows:

[symbol]

=1− [symbol] _{sift}+ [symbol] ₛₕₐₚₑ
where [symbol] denotes the optimization function;
[symbol] _{sift} denotes a cosine similarity of an SIFT feature vector:

$${J}_{sift} ( {T}_{i} ( k ) ) = \frac{{ϕ ( {T}_{i} ( k - 1 ) )}^{T} ϕ ( {T}_{i} ( k ) )}{‖ ϕ ( {T}_{i} ( k - 1 ) ) ‖ ‖ ϕ ( {T}_{i} ( k ) ) ‖}$$

where ϕ(Tᵢ(k−1)) denotes a feature descriptor of the i th second two-dimensional key point Tᵢ(k−1) and is a vector, ϕ(Tᵢ(k)) denotes a feature descriptor of a neighborhood point of the ith third two-dimensional key point Tᵢ(k) and is a vector, and ∥·∥ denotes a norm of the vector; and
[symbol] ₛₕₐₚₑ denotes a difference in cosine values of included angles between adjacent key points on different curves:

$${shape}_{} ( {T}_{i} ( k ) ) = \frac{1}{n} {\sum }_{i = 0}^{n} \vert ℊ ( {T}_{i} ( k - 1 ) ) - ℊ ( {T}_{i} ( k ) ) \vert$$

where g(Tᵢ(k)) is the cosine value of the included angle, which is specifically calculated as follows:

$$ℊ ( {T}_{i} ( k ) ) = \frac{{a}^{T} b}{‖ a ‖ ‖ b ‖}$$

$$where a = {( {T}_{i + 1} ( k ) - {T}_{i} ( k ) )}^{T} , b = {( {T}_{i - 1} ( k ) - {T}_{i} ( k ) )}^{T} .$$

[symbol]

is minimized by traversing and searching for neighborhood points of all third two-dimensional key points Tᵢ(k), so as to satisfy:

\hat{T}ᵢ=argmin(1−J_{sift}(Tᵢ(k))+ [symbol] ₛₕₐₚₑ(Tᵢ(k)))

An ideal key point Tᵢ set can be acquired by minimizing the optimization function.

In the embodiment of the present disclosure, after the transformation matrix is acquired through the three-dimensional affine transformation, the three-dimensional key point is precisely located by constructing the optimization function in combination with the texture information of the endoscopic image and the shape information. Therefore, the effect of the indistinct in-vivo environment feature on a tracking result is avoided to a certain extent.

In step S25, the three-dimensional coordinates of each tracked key point are acquired according to the mapping relation between the point clouds before and after dimension reduction, curve fitting is performed, and the three-dimensional curve is finally obtained by means of tracking.

Specifically, in the present step, interpolation fitting is performed on a line through an equation of a B-spline curve, where a general equation of the B-spline curve is:

P(t)=Σᵢ₌₀^{m}PᵢF_{i,k}(t)
where Pᵢ denotes a feature point of a control curve, F_{i,k}(t) denotes a kth order B-spline basis function, and the three-dimensional curve is tracked through curve interpolation fitting. Pᵢ is acquired by performing mapping on Tᵢ according to the mapping relation between the point clouds before and after dimension reduction.

In conclusion, compared with the prior art, the present embodiment has the beneficial effects as follows:
1. In the embodiment of the present disclosure, the local region is determined through a position of the key point and then tracked to reduce mistracking of the three-dimensional key point. In combination with the texture information of the endoscopic image and the shape information, the effect of the indistinct in-vivo environment feature is avoided to a certain extent. The three-dimensional key point is precisely located by constructing the optimization function on the point cloud after dimension reduction. Therefore, the inconsistency of a curve shape under different viewing angles is avoided.
2. In the present step, the doctor labels the two-dimensional curve on the intraoperative image for subsequent display and update of the curve on the three-dimensional point cloud. Accordingly, the information is transmitted intuitively and accurately, and an operation efficiency is improved; and moreover, the key point is determined according to the curvature of the curve, and a computation speed is ensured for key point tracking.
3. In the embodiment of the present disclosure, after the transformation matrix is acquired through the three-dimensional affine transformation, the three-dimensional key point is precisely located by constructing the optimization function in combination with the texture information of the endoscopic image and the shape information. Therefore, the effect of the indistinct in-vivo environment feature on the tracking result is avoided to a certain extent.

### Embodiment 3

An embodiment of the present disclosure provides a storage medium. The storage medium stores an autonomous operation robot oriented computer program for three-dimensional key point tracking, where the computer program causes a computer to execute the above tracking method for an in-vivo three-dimensional key point.

### Embodiment 4

An embodiment of the present disclosure provides an electronic apparatus. The electronic apparatus includes:
one or more processors;
a memory; and
one or more programs, where the one or more programs are stored in the memory and configured to be executed by the one or more processors, and the program includes executing the above tracking method for an in-vivo three-dimensional key point.

It can be understood that the storage medium and the electronic apparatus according to Embodiment 3 and Embodiment 4 of the present disclosure respectively correspond to the minimally invasive key site navigation oriented dynamic tracking method for an in-vivo three-dimensional key point according to Embodiment 1 of the present disclosure. Reference may be made to the corresponding parts of the tracking method for a three-dimensional key point for the explanations, instances, beneficial effects, etc. of the relevant contents of the storage medium and the electronic apparatus, which will not be repeated herein.

In conclusion, in all the above embodiments, the three-dimensional key point in the in-vivo environment can be precisely and dynamically located and tracked. In addition, for dynamic tracking of the in-vivo three-dimensional curve, since the three-dimensional key point can be precisely and dynamically located and tracked, the in-vivo three-dimensional curve can also be precisely and dynamically located and tracked while the operation path curve can be tracked in real time.

It is to be noted that relational terms herein such as first and second are merely used to distinguish one entity or operation from another entity or operation without necessarily requiring or implying any such an actual relation or order between these entities or operations. In addition, terms “comprise”, “include”, “encompass”, or any other their variations are intended to cover a non-exclusive inclusion. Therefore, a process, method, article, or apparatus including a series of elements not only includes those elements, but also includes other elements that are not explicitly listed, or further includes inherent elements of such a process, method, article, or apparatus. Without more restrictions, the elements defined by the sentence “comprise a . . . ” and “include a . . . ” do not exclude the existence of other identical elements in the process, method, article, or apparatus including the elements.

The above embodiments are only used to explain the technical solutions of the present disclosure, and are not intended to limit same. Although the present disclosure is described in detail with reference to the foregoing embodiments, those of ordinary skill in the art should understand that they can still made modifications to the technical solutions described in all the foregoing embodiments, or make equivalent substitutions to some technical features in the embodiments. These modifications or substitutions do not make the essence of the corresponding technical solutions depart from the spirit and scope of the technical solutions in all the embodiments of the present disclosure.

1-13. (canceled)

14. A minimally invasive key site navigation oriented dynamic tracking method for an in-vivo three-dimensional key point, comprising:
S11, reading an endoscopic image, and acquiring a first two-dimensional key point from a current image according to selection of a doctor;
S12, tracking a first local region encompassing the first two-dimensional key point on the current image, acquiring a second local region from a next image, and determining an initial two-dimensional key point of the first two-dimensional key point on the next image;
S13, mapping the first local region to a first local point cloud and mapping the second local region to a second local point cloud according to a mapping relation between the endoscopic image and the point clouds, determining a first three-dimensional key point of the first two-dimensional key point on the first local point cloud, and acquiring a second three-dimensional key point on the second local point cloud through a coordinate transformation; and
S14, mapping the second three-dimensional key point back to the second local region, so as to acquire a second two-dimensional key point from the next image, acquiring two-dimensional coordinates of a tracked key point by minimizing a preset optimization function in combination with the initial two-dimensional key point, and finally acquiring corresponding three-dimensional coordinates.

15. The tracking method for an in-vivo three-dimensional key point according to claim 14, wherein S12 comprises:
S121, defining a k−1th image as I(k−1)∈ [symbol] ^{W×H×3}, wherein W denotes a width of the endoscopic image, H denotes a height of the endoscopic image, I(k) denotes a kth image, and p(k−1) denotes a first two-dimensional key point, coordinates of which are (u₁, v₁); and
taking the first two-dimensional key point p(k−1) as a center p^{c}(k−1) of the first local region, and determining a first local region R(k−1) according to a preset region shape and side length;
S122, performing feature matching on feature points of images I(k31 1), I(k) through an optical flow method, and acquiring a center p^{c}(k), corresponding to p^{c}(k−1), of the second local region from the image I(k),
$${p}^{c} ( k ) = {p}^{c} ( k - 1 ) + \frac{1}{m} {\sum }_{i = 1}^{m} ( {p}_{i}^{f} ( k ) - {p}_{i}^{f} ( k - 1 ) )$$
wherein p^{f}(k)={p₁^{f}(k), p₂^{f}(k), . . . , pₘ^{f}(k)} denotes a feature point on the image I(k), and m denotes the number of the feature point on the image I(k);
S123, determining a second local region [symbol] (k) according to the center p^{c}(k) and the preset region shape and side length; and
S124, directly determining an initial two-dimensional key point p^{o}(k) of the first two-dimensional key point p(k−1) on the next image still through the optical flow method.

16. The dynamic tracking method for an in-vivo three-dimensional key point according to claim 15, wherein S13 comprises:
S131, estimating a depth of the endoscopic image to obtain a depth image corresponding to the endoscopic image, acquiring space information and color information of each pixel from the depth image and the endoscopic image respectively through reading in rows, and acquiring a first local point cloud [symbol] (k−1) and a second local point cloud [symbol] (k);
S132, determining a first three-dimensional key point P(k−1)∈ [symbol] ³ of the first two-dimensional key point p(k−1) on the first local point cloud [symbol] (k−1),
P(k−1)=ψ(p(k−1))
wherein ψ denotes a mapping relation from [symbol] (k−1) to [symbol] (k −1), which is recorded as [symbol] (k−1)→ [symbol] (k −1);
S133, acquiring a feature point pair of the local regions [symbol] (k−1), [symbol] (k) through the optical flow method and recording same as X and Y, respectively, so that X and Y are in a coordinate transformation relation:
$$Y = [ \begin{matrix}A & t\end{matrix} ] [ \begin{matrix}X \\ 1\end{matrix} ]$$
wherein A∈ [symbol] ^{3×3}, t∈ [symbol] ^{3×1}, ω=[A t]^{T}∈ [symbol] ^{4×3} denote parameters of a fitting function, ω is acquirable from the following formula through least squares:
ω=([X1]^{T}[X1])⁻¹[X1]^{T}Y
and a transformation matrix of an affine transformation of P(k−1), P(k) is:
$${T}_{A} = [ \begin{matrix}A & t \\ {0}^{T} & 1\end{matrix} ] ∈ {ℝ}^{4 \times 4}$$
wherein 0^{T}=(0,0,0); and
S134, performing a three-dimensional affine transformation on the first three-dimensional key point P(k−1), wherein a matrix form is:
P(k)=T_{A}P(k−1)
and searching for a nearest point from the second local point cloud [symbol] (k) to obtain an initial position of a second three-dimensional key point P(k).

17. The dynamic tracking method for an in-vivo three-dimensional key point according to claim 14, wherein the optimization function in S14 is as follows: [symbol]
=2− [symbol] _{sift}− [symbol] _{optical}
wherein [symbol] denotes the optimization function; [symbol]
_{sift} denotes a cosine similarity of a scale invariant feature transform (SIFT) feature vector:
$${J}_{sift} ( Δ u , Δ v , k ) = \frac{{ϕ ( p ( k - 1 ) )}^{T} ϕ ( {p}_{u + Δ u , v + Δ v} ( k ) )}{‖ ϕ ( p ( k - 1 ) ) ‖ ‖ ϕ ( {p}_{u + Δ u , v + Δ v} ( k ) ) ‖}$$
wherein ϕ(p(k−1)) denotes a feature descriptor of the first two-dimensional key point p(k−1) and is a vector, ∥·∥ denotes a norm of the vector, (u, v) denote coordinates of the second two-dimensional key point p(k), p_{u+Δu,v+Δv}(k) denotes a neighborhood point of the second two-dimensional key point p(k), Δu and Δv are coordinate offset of the second two-dimensional key point p(k), ϕ(p_{u+Δu,v+Δv}(k)) denotes a feature descriptor of the neighborhood point p_{u+Δu,v+Δv}(k) and is a vector, and [symbol]
_{optical} denotes an effect of optical flow information:
$${J}_{optical} ( Δ u , Δ v , k ) = \frac{{a}^{T} b}{‖ a ‖ ‖ b ‖}$$
wherein
a=(p_{u+Δu,v+Δv}(k)−p(k))^{T},b=(p^{o}(k)−p(k))^{T}.

18. The dynamic tracking method for an in-vivo three-dimensional key point according to claim 15, wherein the optimization function in S14 is as follows: [symbol]
=2− [symbol] _{sift}− [symbol] _{optical}
wherein [symbol] denotes the optimization function; [symbol]
_{sift} denotes a cosine similarity of a scale invariant feature transform (SIFT) feature vector:
$${J}_{sift} ( Δ u , Δ v , k ) = \frac{{ϕ ( p ( k - 1 ) )}^{T} ϕ ( {p}_{u + Δ u , v + Δ v} ( k ) )}{‖ ϕ ( p ( k - 1 ) ) ‖ ‖ ϕ ( {p}_{u + Δ u , v + Δ v} ( k ) ) ‖}$$
wherein ϕ(p(k−1)) denotes a feature descriptor of the first two-dimensional key point p(k−1) and is a vector, ∥·∥ denotes a norm of the vector, (u, v) denote coordinates of the second two-dimensional key point p(k), p_{u+Δu,v+Δv}(k) denotes a neighborhood point of the second two-dimensional key point p(k), Δu and Δv are coordinate offset of the second two-dimensional key point p(k), ϕ(p_{u+Δu,v+Δv}(k)) denotes a feature descriptor of the neighborhood point p_{u+Δu,v+Δv}(k) and is a vector, and [symbol]
_{optical} denotes an effect of optical flow information:
$${J}_{optical} ( Δ u , Δ v , k ) = \frac{{a}^{T} b}{‖ a ‖ ‖ b ‖}$$
wherein
a=(p_{u+Δu,v+Δv}(k)—p(k))^{T},b=(p^{o}(k)−p(k))^{T}.

19. The dynamic tracking method for an in-vivo three-dimensional key point according to claim 16, wherein the optimization function in S14 is as follows: [symbol]
=2− [symbol] _{sift}− [symbol] _{optical}
wherein [symbol] denotes the optimization function; [symbol]
_{sift} denotes a cosine similarity of a scale invariant feature transform (SIFT) feature vector:
$${J}_{sift} ( Δ u , Δ v , k ) = \frac{{ϕ ( p ( k - 1 ) )}^{T} ϕ ( {p}_{u + Δ u , v + Δ v} ( k ) )}{‖ ϕ ( p ( k - 1 ) ) ‖ ‖ ϕ ( {p}_{u + Δ u , v + Δ v} ( k ) ) ‖}$$
wherein ϕ(p(k−1)) denotes a feature descriptor of the first two-dimensional key point p(k−1) and is a vector, ∥·∥ denotes a norm of the vector, (u, v) denote coordinates of the second two-dimensional key point p(k), p_{u+Δu,v+Δv}(k) denotes a neighborhood point of the second two-dimensional key point p(k), Δu and Δv are coordinate offset of the second two-dimensional key point p(k), ϕ(p_{u+Δu,v+Δv}(k)) denotes a feature descriptor of the neighborhood point p_{u+Δu,v+Δv}(k) and is a vector, and [symbol]
_{optical} denotes an effect of optical flow information:
$${J}_{optical} ( Δ u , Δ v , k ) = \frac{{a}^{T} b}{‖ a ‖ ‖ b ‖}$$
wherein
a=(p_{u+Δu,v+Δv}(k)−p(k))^{T},b=(p^{o}(k)−p(k))^{T}.

20. The dynamic tracking method for an in-vivo three-dimensional key point according to claim 17, wherein the acquiring two-dimensional coordinates of a tracked key point by minimizing a preset optimization function, and finally acquiring corresponding three-dimensional coordinates in S14 comprises:
acquiring Δû and Δ\hat{v} by traversing and searching for Δu and Δv, so as to satisfy the following expression:
$$( Δ \hat{u} ( k ) , Δ \hat{v} ( k ) ) = {argmin}_{( Δ u , Δ v )} ( J ( Δ u , Δv , k ) )$$
and acquiring two-dimensional coordinates of a tracked key point p_{u+Δu,v+Δv}(k) after ideal offset (Δû(k), Δ\hat{v}(k)) is obtained, and then finally acquiring corresponding three-dimensional coordinates according to the mapping relation between the endoscopic image and the point clouds.

21. An electronic apparatus, comprising:
one or more processors;
a memory; and
one or more programs, wherein the one or more programs are stored in the memory and configured to be executed by the one or more processors, and the program comprises executing the dynamic tracking method for an in-vivo three-dimensional key point according to claim 14.

22. The electronic apparatus according to claim 21, wherein S12 comprises:
S121, defining a k−1th image as I(k−1)∈ [symbol] ^{W×H×3} wherein W denotes a width of the endoscopic image, H denotes a height of the endoscopic image, I(k) denotes a kth image, and p(k−1) denotes a first two-dimensional key point, coordinates of which are (u₁, v₁); and
taking the first two-dimensional key point p(k−1) as a center p^{c}(k−1) of the first local region, and determining a first local region [symbol] (k−1) according to a preset region shape and side length;
S122, performing feature matching on feature points of images I(k−1), I(k) through an optical flow method, and acquiring a center p^{c}(k), corresponding to p^{c}(k−1), of the second local region from the image I(k),
$${p}^{c} ( k ) = {p}^{c} ( k - 1 ) + \frac{1}{m} {\sum }_{i = 1}^{m} ( {p}_{i}^{f} ( k ) - {p}_{i}^{f} ( k - 1 ) )$$
wherein p^{f}(k)={p₁^{f}(k), p₂^{f}(k), . . . , pₘ^{f}(k)} denotes a feature point on the image I(k), and m denotes the number of the feature point on the image I(k);
S123, determining a second local region [symbol] (k) according to the center p^{c}(k) and the preset region shape and side length; and
S124, directly determining an initial two-dimensional key point p^{o}(k) of the first two-dimensional key point p(k−1) on the next image still through the optical flow method.

23. The electronic apparatus according to claim 22, wherein S13 comprises:
S131, estimating a depth of the endoscopic image to obtain a depth image corresponding to the endoscopic image, acquiring space information and color information of each pixel from the depth image and the endoscopic image respectively through reading in rows, and acquiring a first local point cloud [symbol] (k−1) and a second local point cloud [symbol] (k);
S132, determining a first three-dimensional key point P(k−1)∈ [symbol] ³ of the first two-dimensional key point p(k−1) on the first local point cloud [symbol] (k−1),
P(k−1)=ψ(p(k−1))
wherein ψ denotes a mapping relation from [symbol] (k−1) to [symbol] (k−1), which is recorded as [symbol] (k−1)→ [symbol] (k−1);
S133, acquiring a feature point pair of the local regions [symbol] (k−1), [symbol] (k) through the optical flow method and recording same as X and Y, respectively, so that X and Y are in a coordinate transformation relation:
$$Y = [ A t ] [ \begin{matrix}x \\ 1\end{matrix} ]$$
wherein A∈ [symbol] ^{3×3}, t∈ [symbol] ^{3×1}, ω=[A t]^{T}∈ [symbol] ^{4×3} denote parameters of a fitting function, ω is acquirable from the following formula through least squares:
ω=[X1]^{T}[X1])⁻¹[X1]^{T}Y
and a transformation matrix of an affine transformation of P(k−1), P(k) is:
$${T}_{A} = [ \begin{matrix}A & t \\ {0}^{T} & 1\end{matrix} ] ∈ {ℝ}^{4 \times 4}$$
wherein 0^{T}=(0,0,0); and
S134, performing a three-dimensional affine transformation on the first three-dimensional key point P(k−1), wherein a matrix form is:
P(k)=T_{A}P(k−1)
and searching for a nearest point from the second local point cloud [symbol] (k) to obtain an initial position of a second three-dimensional key point P(k).

24. The electronic apparatus according to claim 21, wherein the optimization function in S14 is as follows: [symbol]
=2− [symbol] _{sift}− [symbol] _{optical}
wherein [symbol] denotes the optimization function; [symbol]
_{sift} denotes a cosine similarity of a scale invariant feature transform (SIFT) feature vector:
$${J}_{sift} ( Δ u , Δ v , k ) = \frac{{ϕ ( p ( k - 1 ) )}^{T} ϕ ( {p}_{u + Δ u , v + Δ v} ( k ) )}{‖ ϕ ( p ( k - 1 ) ) ‖ \vert ‖ ϕ ( {p}_{u + Δ u , v + Δ v} ( k ) ) ‖}$$
wherein ϕ(p(k−1)) denotes a feature descriptor of the first two-dimensional key point p(k−1) and is a vector, ∥·∥ denotes a norm of the vector, (u, v) denote coordinates of the second two-dimensional key point p(k), p_{u+Δu,v+Δv}(k) denotes a neighborhood point of the second two-dimensional key point p(k), Δu and Δv are coordinate offset of the second two-dimensional key point p(k), ϕ(p_{u+Δu,v+Δv}(k)) denotes a feature descriptor of the neighborhood point p_{u+Δu,v+Δv}(k) and is a vector, and [symbol]
_{optical} denotes an effect of optical flow information:
$${J}_{optical} ( Δ u , Δ v , k ) = \frac{{a}^{T} b}{‖ a \vert ‖ ‖ b ‖}$$
wherein
a=(p_{u+Δu,v+Δv}(k)−p(k))^{T},b=(p^{o}(k)−p(k))^{T}.

25. The electronic apparatus according to claim 24, wherein the acquiring two-dimensional coordinates of a tracked key point by minimizing a preset optimization function, and finally acquiring corresponding three-dimensional coordinates in S14 comprises:
acquiring Δû and Δ\hat{v} by traversing and searching for Δu and Δv, so as to satisfy the following expression:
$$( Δ û Δ \hat{v} ( k ) ) = {arg min}_{( Δ u , Δ v )} ( J ( Δ u , Δ v , k ) )$$
and acquiring two-dimensional coordinates of a tracked key point p_{u+Δu,v+Δv}(k) after ideal offset (Δû(k), Δ\hat{v}(k)) is obtained, and then finally acquiring corresponding three-dimensional coordinates according to the mapping relation between the endoscopic image and the point clouds.

26. A minimally invasive key trajectory navigation oriented dynamic tracking method for an in-vivo three-dimensional curve, comprising:
S21, reading an endoscopic image, acquiring an operation path curve from a current image according to selection of a doctor, and acquiring a plurality of first two-dimensional key points through which the operation path curve passes;
S22, tracking a first local region encompassing the first two-dimensional key point on the current image, and acquiring a second local region from a next image;
S23, mapping the first local region to a first local point cloud and mapping the second local region to a second local point cloud according to a mapping relation between the endoscopic image and the point clouds, determining a first three-dimensional key point of the first two-dimensional key point on the first local point cloud, and acquiring a second three-dimensional key point on the second local point cloud through a coordinate transformation;
S24, reducing a dimension of the first local point cloud to obtain a first two-dimensional point cloud, and acquiring a second two-dimensional key point of the first three-dimensional key point on the first two-dimensional point cloud;
reducing a dimension of the second local point cloud to obtain a second two-dimensional point cloud, and acquiring a third two-dimensional key point of the second three-dimensional key point on the second two-dimensional point cloud; and
acquiring two-dimensional coordinates of a tracked key point on the two-dimensional point cloud by minimizing a preset optimization function according to the second two-dimensional key point and the third two-dimensional key point; and
S25, acquiring three-dimensional coordinates of each tracked key point according to a mapping relation between the point clouds before and after dimension reduction, performing curve fitting, and finally obtaining a three-dimensional curve by means of tracking.

27. The dynamic tracking method for an in-vivo three-dimensional curve according to claim 26, wherein S22 comprises:
S221, defining a k−1th image a I/(k−1)∈ [symbol] ^{W×H×3}, wherein W denotes a width of the endoscopic image, H denotes a height of the endoscopic image, I(k) denotes a kth image, and [symbol] (k−1)={p₁(k−1), . . . , pₙ(k−1)} denote a plurality of first two-dimensional key points; and
determining maximums and minimums of all the first two-dimensional key points on a u axis and a v axis of an image coordinate system, respectively, selecting a position of a median on each axis as p^{c}(k−1)=(u₁, v₁)∈R², and determining a first local region [symbol] (k−1) according to a preset region shape and side length;
S222, performing feature matching on feature points of images I(k−1), I(k) through an optical flow method, and acquiring a center p^{c}(k), corresponding to p^{c}(k−1), of the second local region from the image I(k),
$${p}^{c} ( k ) = {p}^{c} ( k - 1 ) + \frac{1}{m} {\sum }_{i = 1}^{m} ( {p}_{i}^{f} ( k ) - {p}_{i}^{f} ( k - 1 ) )$$
where p^{f}(k)={p₁^{f}(k), p₂^{f}(k), . . . , pₘ^{f}(k)} denotes a feature point on the image I(k), and m denotes the number of the feature point on the image I(k); and
S223, determining a second local region [symbol] (k) according to the center p^{c}(k) and the preset region shape and side length.

28. The dynamic tracking method for an in-vivo three-dimensional curve according to claim 27, wherein S23 comprises:
S231, estimating a depth of the endoscopic image to obtain a depth image corresponding to the endoscopic image, acquiring space information and color information of each pixel from the depth image and the endoscopic image respectively through reading in rows, and acquiring a first local point cloud [symbol] (k−1) and a second local point cloud [symbol] (k);
S232, determining a first three-dimensional key point [symbol] (k−1)={P₁(k−1), . . . , Pₙ(k−1)}⊂ [symbol] (k−1), Pᵢ(k−1)∈ [symbol] ³ of the first two-dimensional key point [symbol] (k−1) on the first local point cloud [symbol] (k−1),
Pᵢ(k−1)=ψ(pᵢ(k−1))
wherein ψ denotes a mapping relation from [symbol] (k−1) to [symbol] (k−1), which is recorded as [symbol] (k−1)→ [symbol] (k−1);
S233, acquiring a feature point pair of the local regions [symbol] (k−1), [symbol] (k) through the optical flow method and recording same as X and Y, respectively, so that X and Y are in a coordinate transformation relation:
$$Y = [ A t ] [ \begin{matrix}X \\ 1\end{matrix} ] \qquad [ x1 ]$$
wherein A∈ [symbol] ^{3×3}, t∈ [symbol] ^{3×1}, ω=[A t]^{T}∈ [symbol] ^{4×3} denote parameters of a fitting function, ω is acquirable from the following formula through least squares:
ω=([X1]^{T}[X1])⁻¹[X1]^{T}Y
and a transformation matrix of an affine transformation of P(k−1), P(k) is:
$${T}_{A} = [ \begin{matrix}A & t \\ {0}^{T} & 1\end{matrix} ] ∈ {ℝ}^{4 \times 4}$$
wherein 0^{T}=(0,0,0); and
S234, performing a three-dimensional affine transformation on the first three-dimensional key point P(k−1), and searching for a nearest point from the second local point cloud [symbol] (k) to obtain an initial position of a second three-dimensional key point P(k), wherein
P(k)=T_{A}P(k−1).

29. The dynamic tracking method for an in-vivo three-dimensional curve according to claim 26, wherein the optimization function in S24 is as follows: [symbol]
=1− [symbol] _{sift}+ [symbol] ₛₕₐₚₑ
where [symbol] denotes the optimization function; [symbol]
_{sift} denotes a cosine similarity of an SIFT feature vector:
$${J}_{sift} ( {T}_{i} ( k ) ) = \frac{{ϕ ( {T}_{i} ( k - 1 ) )}^{T} ϕ ( {T}_{i} ( k ) )}{‖ ϕ ( {T}_{i} ( k - 1 ) ) ‖ ‖ ϕ ( {T}_{i} ( k ) ) ‖}$$
wherein ϕ(Tᵢ(k−1)) denotes a feature descriptor of an ith second two-dimensional key point Tᵢ(k−1) and is a vector, ϕ(Tᵢ(k)) denotes a feature descriptor of a neighborhood point of an ith third two-dimensional key point Tᵢ(k) and is a vector, and ∥·∥ denotes a norm of the vector; and [symbol]
ₛₕₐₚₑ denotes a difference in cosine values of included angles between adjacent key points on different curves:
$${𝔍}_{s h a p e} ( {T}_{i} ( k ) ) = \frac{1}{n} {\sum }_{i = 0}^{n} \vert g ( {T}_{i} ( k - 1 ) ) - g ( {T}_{i} ( k ) ) \vert$$
wherein g(Tᵢ(k)) is the cosine value of the included angle, which is specifically calculated as follows:
$$g ( {T}_{i} ( k ) ) = \frac{{a}^{T} b}{‖ a ‖ ‖ b ‖}$$
wherein a=(Tᵢ₊₁(k)−Tᵢ(k))^{T},b=(Tᵢ₋₁(k)−Tᵢ(k))^{T}.

30. The dynamic tracking method for an in-vivo three-dimensional curve according to any one of claim 27, wherein the optimization function in S24 is as follows: [symbol]
=1− [symbol] _{sift}+ [symbol] ₛₕₐₚₑ
wherein [symbol] denotes the optimization function; [symbol]
_{sift} denotes a cosine similarity of an SIFT feature vector:
$${J}_{sift} ( {T}_{i} ( k ) ) = \frac{{ϕ ( {T}_{i} ( k - 1 ) )}^{T} ϕ ( {T}_{i} ( k ) )}{‖ ϕ ( {T}_{i} ( k - 1 ) ) ‖ ‖ ϕ ( {T}_{i} ( k ) ) ‖}$$
wherein ϕ(Tᵢ(k−1)) denotes a feature descriptor of an ith second two-dimensional key point Tᵢ(k−1) and is a vector, ϕ(Tᵢ(k)) denotes a feature descriptor of a neighborhood point of an ith third two-dimensional key point Tᵢ(k) and is a vector, and ∥·∥ denotes a norm of the vector; and [symbol]
ₛₕₐₚₑ denotes a difference in cosine values of included angles between adjacent key points on different curves:
$${𝔍}_{s h a p e} ( {T}_{i} ( k ) ) = \frac{1}{n} {\sum }_{i = 0}^{n} \vert g ( {T}_{i} ( k - 1 ) ) - g ( {T}_{i} ( k ) ) \vert$$
wherein g(Tᵢ(k)) is the cosine value of the included angle, which is specifically calculated as follows:
$$g ( {T}_{i} ( k ) ) = \frac{{a}^{T} b}{‖ a ‖ ‖ b ‖}$$
wherein a=(Tᵢ₊₁(k)−Tᵢ(k))^{T},b=(Tᵢ₋₁(k)−Tᵢ(k))^{T}.

31. The dynamic tracking method for an in-vivo three-dimensional curve according to claim 29, wherein the acquiring two-dimensional coordinates of a tracked key point on the two-dimensional point cloud by minimizing a preset optimization function according to the second two-dimensional key point and the third two-dimensional key point in S24 comprises:
minimizing [symbol] by traversing and searching for neighborhood points of all third two-dimensional key points Tᵢ(k), so as to satisfy:
\hat{T}ᵢ=argmin(1− [symbol] _{sift}(Tᵢ(k))+ [symbol] ₛₕₐₚₑ(Tᵢ(k)))
and acquiring an ideal key point Tᵢ set by minimizing the optimization function.

32. The dynamic tracking method for an in-vivo three-dimensional curve according to claim 29, wherein the performing curve fitting, and finally obtaining a three-dimensional curve by means of tracking in S25 comprises:
performing interpolation fitting on a line through an equation of a B-spline curve, wherein a general equation of the B-spline curve is P(t)=Σᵢ₌₀ⁿ Pᵢ F_{i,k}(t):
wherein Pᵢ denotes a feature point of a control curve, F_{i,k}(t) denotes a kth order B-spline basis function, and the three-dimensional curve is tracked through curve interpolation fitting.

33. The dynamic tracking method for an in-vivo three-dimensional curve according to claim 29, wherein a first two-dimensional key point acquisition process in S21 comprises:
defining [symbol] ^{p}={p₀^{p}, . . . , pⱼ^{p}, . . . , pₗ₋₁^{p}} as a pixel through which the operation path curve passes;
wherein
for a point on the curve, a curvature of a jth pixel on the curve is:
$${K}_{j} = \frac{{v}_{j + α} - {v}_{j}}{{u}_{j + α} - {u}_{j}} , j = 0 , α , 2 α … , j < l - 1 ,$$
wherein p_{j+α}^{p}=[u_{j+α} v_{j+α}] denotes coordinates of a j+αth pixel on the curve, and a denotes an interval number of the pixels when the curvature of the pixel is solved; and
for curvatures of two consecutive pixels, when |K_{j+α}−Kⱼ|≥ε, ε denotes a curvature threshold; and determining all first two-dimensional key points [symbol] ={p₁, . . . , pᵢ, . . . , pₙ} in combination with p_{j+α}^{p} as a key point on the operation path curve and a start point and an end point of the curve, wherein n denotes a total number of the first two-dimensional key points.
